(19) United States
(12) Patent Application Publication
(10) Pub. No.: US 2002/0154851 A1
(43) Pub. Date: Oct. 24, 2002

(54) Optical modular switching system

(76) Inventors: J. Andrew Yeh, Pleasant Hill, CA (US); Norman C. Tien, Davis, CA (US); Weijie Yun, San Jose, CA (US); Chang-Lin Tien, Berkeley, CA (US)

Correspondence Address: PENNIE & EDMONDS LLP, 3300 Hillview Avenue, Palo Alto, CA, 94304, US

(21) Appl. No.: 09/838,048

(22) Filed: Apr. 18, 2001

(51) Int. Cl. G02B 6/26; G02B 6/42

(52) U.S. Cl. 385/16

(57) ABSTRACT

An optical modular switching system comprising a first optical switch module having at least one first optical input port, at least one first optical output port, and at least one first interconnect port. The optical modular switching system also comprises a second optical switch module having at least one second optical input port, at least one second optical output port, and at least one second interconnect port. Finally, the optical modular switching system comprises an optical interconnect that optically couples the first optical interconnect port to the second optical interconnect port. The invention also provides a method for switching an optical signal. Additional optical switch modules can be added to incrementally grow the optical modular switching system.

### TECHNICAL FIELD

The invention relates generally to fiber optics and micro-electromechanical systems (MEMS) or micro-optical-electromechanical systems (MOEMS). More particularly, the invention is directed to an optical modular switching system configured to optically switch between multiple optical fibers, switches, or optical cross-connects.

### BACKGROUND OF THE INVENTION

Fiber optics is the science or technology of light transmission through very fine, flexible glass or plastic fibers. These flexible fibers are typically bundled together into fiber optic cables, which are used in the telecommunications industry to transmit data. As the amount of data transmitted along separate fibers differ, it is desirable to dynamically allocate bandwidth over multiple fibers. This requires very quickly connecting and disconnecting between the fibers, where the connecting and disconnecting is know as switching. Furthermore, it is necessary to quickly switch signals between different customers, geographies, etc.

Historically, switching between different optical fibers was made using optical-electrical-optical (OEO) switches, which are network devices used to switch electrical signals by converting an optical signal to an electrical signal, switching the electrical signal, and converting the switched electrical signal back into an optical signal. These OEO switches are network communication protocol dependent, consume more-power than all-optical switches, and have higher cross talk. Furthermore, OEO switches act as bottlenecks in a data stream of an optical network, since the electrical switching is slower than the optical data transmission rate. To address this, purely optical components, such as optical switches, optical matrices, and optical cross-connects, are currently under development. These optical components switch high-speed optical signals and work entirely at the optical layer without having to convert to an electrical signal and back again.

A recent development for manufacturing these optical components utilizes micro-electromechanical systems (MEMS) technology. Micro-electromechanical systems combine electronics with micro scale mechanical devices, resulting in microscopic machinery, such as sensors, valves, gears, mirrors, and actuators embedded in semiconductor chips. The MEMS manufacturing process is similar to that used in the semiconductor industry, wherein silicon wafers are patterned via photolithography and etched in batch.

One class of MEMS optical devices use small, movable mirrors to redirect laser light from an input fiber to an output fiber in an N×N matrix, where N input fibers can be arbitrarily linked to N output fibers. These type of MEMS optical devices are known as optical cross-connects or switches. Two dominant architectures have emerged for optical cross-connects based on movable MEMS mirrors, namely the so-called N² and 2N type MEMS optical cross-connects.

FIG. 1A is a diagrammatic top view of a prior art N² type optical switch module 1100. The N² type optical switch module 100 uses mirrors 102 that can only rotate through a limited number of discrete positions. One active mirror 104 is shown reflecting light 106 from an input port 108 to an output port 110. The remainder of the mirrors 102 in the row and column that the light is directed along, are positioned such that they do not interfere with the light beam. Implementing this architecture requires N² mirrors to create an N×N cross-connect. The addition of an input and output port set requires an additional row and column of mirrors, implying that the cross-connect cost is proportional to N².

FIG. 1B is a diagrammatic top view of a prior art 2N type optical switch module 120. The 2N type optical switch module architecture is superior to the N² type optical switch module in that only 2*N mirrors 122 are required, although each mirror 122 must now be able to rotate through numerous positions. These multi-position mirrors 122 complicate the design, fabrication, and control of each mirror, thereby making the 2N architecture more expensive per mirror than the N² architecture. The benefit of a 2N optical cross-connect is that each additional input and output port set requires only two new mirrors, implying that the cross-connect cost is linearly proportional to N.

Customers of optical switches typically initially install small, for example 16×16, optical switches. Later, as their demands grows, they install larger switches, for example 64×64, optical switches. While OEO cross-connects may be bought in modular form, adding capacity incrementally as need arises, no such system currently exists for optical-only systems. Currently, when an increase in capacity is desired, the smaller optical switch must be replaced by a larger optical switch. Besides having obvious cost implications, swapping out switches requires down-time while the customer disconnects and removes the smaller optical switch to replace it with a larger optical switch.

In light of the above, a need exists for an all optical modular switching system that retains the speed associated with a pure optical network, while allowing for modular upgradability and scalability.

### SUMMARY OF THE INVENTION

An optical switching system with a first optical switch module is modularly upgraded by using an optical interconnect in conjunction with a second optical switch module to increase the number of input and output ports of the optical switching system. The modular architecture allows the optical modular switching system to grow from a small switch to a larger switch incrementally, without removing or replacing the first optical switch.

The present invention is formed by optically coupling several optical switch modules together, where each optical switch module is preferably a separate N² or 2N optical switch.

More specifically, the invention provides an optical modular switching system that comprises of a first optical switch module having at least one first optical input port, at least one first optical output port, and at least one first interconnect port. The optical modular switching system also comprises a second optical switch module having at least one second optical input port, at least one second optical output port, and at least one second interconnect port. Finally, the optical modular switching system comprises an optical interconnect that optically couples the first optical interconnect port to the second optical interconnect port. Additional optical switch modules can be added to incrementally grow the optical modular switching system. Furthermore, in a preferred embodiment, each module is identical to each of the other modules.

The invention also provides a method for switching an optical signal. An optical signal is firstly received at an input port of a first optical switch module. The optical signal is routed to a first optical interconnect port of the first optical switch module. The optical signal is then guided to a second interconnect port of a second optical switch module. Subsequently, the optical signal is directed to an output port of the second optical switch module. Finally, the optical signal is transmitted from the output port.

### BRIEF DESCRIPTION OF THE DRAWINGS

For a better understanding of the nature and objects of the invention, reference should be made to the following detailed description, taken in conjunction with the accompanying drawings, in which:

FIG. 1A is a diagrammatic plan view of a prior art N² type optical switch module;

FIG. 1B is a diagrammatic plan view of a prior art 2N type optical switch module;

FIG. 2A is a diagrammatic plan view of a N² optical switch module for use in an optical modular switching system according to an embodiment of the invention;

FIG. 2B is a diagrammatic plan view of a 2N optical switch module for use in an optical modular switching system according to another embodiment of the invention;

FIG. 2C is a diagrammatic plan view of blocking-type movable mirrors for use in either of the optical switch modules 200 or 220 of FIGS. 2A and 2B, respectively;

FIG. 2D is a diagrammatic plan view of a multiple position movable mirror for use in either of the optical switch modules 200 or 220 of FIGS. 2A and 2B, respectively;

FIG. 3 is a diagrammatic representation of an optical modular switching system according to an embodiment of the invention;

FIG. 4 is a oblique view of optical switch module according to an embodiment of the invention;

FIG. 5 is a diagrammatic partial cross-sectional view of an optical modular switching system according to an embodiment of the invention;

FIGS. 6A-G are a cross-sectional diagrammatic view of a preferred embodiment of the optical interconnect of FIG. 5; and

FIG. 7 is a flow chart of a method for switching an optical signal according to an embodiment of the invention.

Like reference numerals refer to corresponding parts throughout the several views of the drawings.

### DETAILED DESCRIPTION OF THE PREFERRED EMBODIMENTS

To address the aforementioned drawbacks of the prior art, an all-optical modular switching system with favorable scalability has been developed. The optical modular switching system of the present invention allows multiple distinct optical switch modules to interconnect optical signals between one another. Furthermore, the optical modular switching system is scalable, allowing additional optical switch modules to be added to the optical modular switching system.

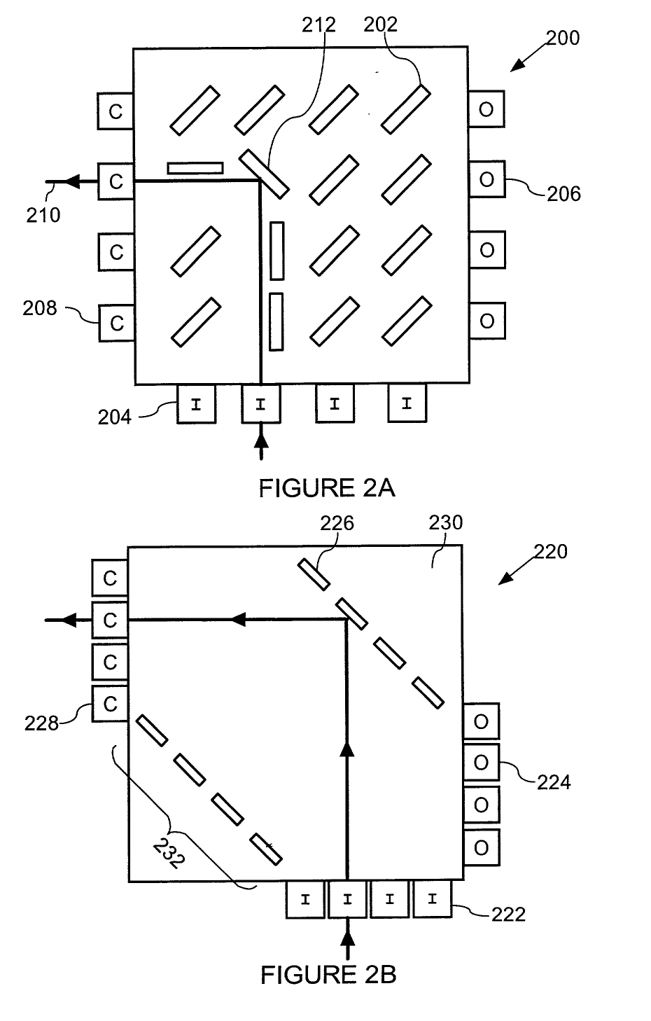

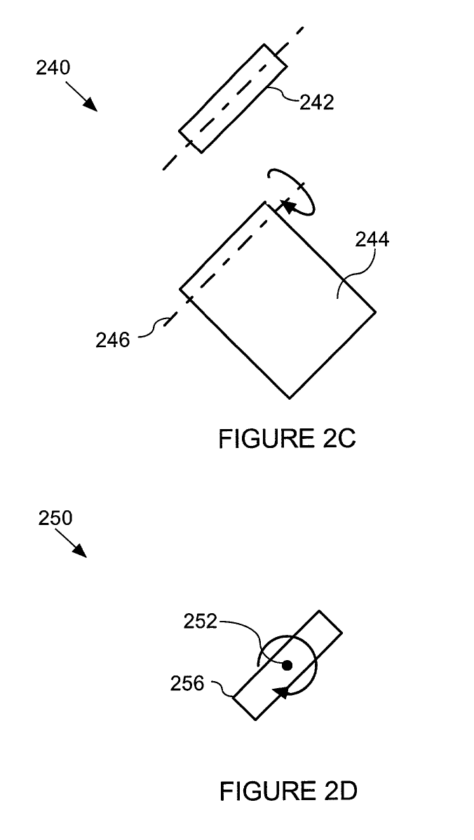

FIG. 2A is a diagrammatic plan view of a N² optical switch module 200 for use in an optical modular switching system, according to an embodiment of the invention. The N² optical switch module 200 comprises multiple mirrors 202 that can rotate through a limited number of discrete positions. The N² optical switch module 200 includes multiple optical input ports 204 and multiple optical output ports 206. The mirrors 202 can be rotated so as to reflect light received from any input port 204, toward any output port 206. In an alternative embodiment, the number of input ports is not the same as the number of output ports.

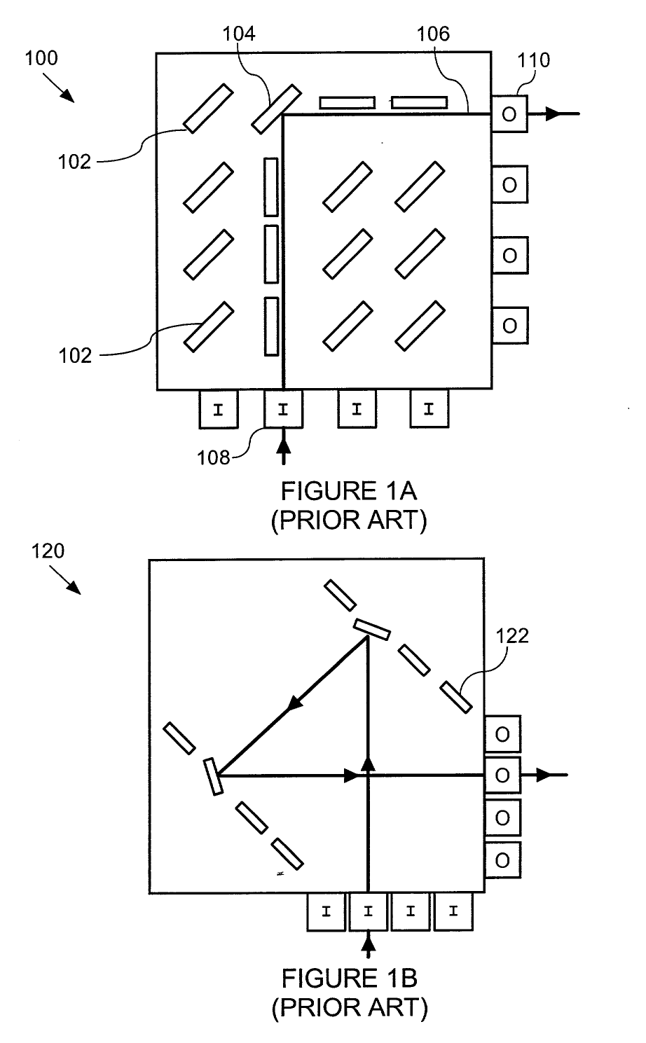

The N² optical switch module 200 further includes one or more interconnect port(s) 208. The mirrors 202 can also be rotated so as to redirect light received from any input port 204 to any of the interconnect port(s) 208. In a preferred embodiment, there are as many interconnect port(s) 208 as there are input ports 204. As shown, an active mirror 212 reflects light 210 from an input port 204 toward an interconnect port 208. The remainder of the mirrors 202 in the row and column that the light is directed along, are positioned such that they do not interfere with the redirected light 210. Implementing this architecture requires N² mirrors to create an N×N optical switch. Each additional input, output and interconnect port requires an additional row and column of mirrors, implying that the module cost is proportional to N². The optical switch module 200 is slightly more complex than the switch module 100 shown in FIG. 1A, because each mirror is required to rotate to more distinct positions in order to additionally redirect light toward the interconnect port(s).

FIG. 2B is a diagrammatic plan view of a 2N optical switch module 220 for use in an optical modular switching system according to another embodiment of the invention. The 2N switch module 220 includes multiple input ports 222 and multiple output ports 224. The 2N switch module 220 also comprises one or more interconnect port(s) 228. Two scanning mirror arrays 232 comprising of multiple mirrors 226 that are used to guide light received from an input port 222 to either an output port 224 or an interconnect port 228. In a preferred embodiment there are 2*N number of mirrors, where N is the number of input ports.

The 2N switch module 220 architecture is superior to the N² type optical switch module in that only 2*N mirrors 226 are required. Each mirror 226 must rotate through more positions than the N² mirrors described above. These multi-position mirrors 226 complicate the design, fabrication, and control of each mirror, thereby making the 2N switch module architecture more expensive per mirror than the N² switch module architecture. The benefit of a 2N optical cross-connect is that each additional input and output port set requires only two mirrors, implying that the system cost is linearly proportional to N.

To route light from an input port 222 to an output port 224, light is reflected by at least two mirrors 226. To route light from an input port 222 to an interconnect port 228, light is reflected by one or more mirrors 226. In a similar manner, optical signals received at interconnect port(s) 228 can be routed to output ports 224.

FIG. 2C is a diagrammatic plan view of blocking-type movable mirrors 240 for use in the optical switch module 200(FIG. 2A). A mirror 244 is shown in an “OFF” position parallel with a plane to which it is rotatively connected, i.e., its actuation plane. When required to reflect an incoming beam of light, the mirror 244 is rotated about an axis 246 into an “ON” position 242 that is perpendicular to the actuation plane. In this way, the blocking-type movable mirrors 240 only move between two positions, namely an “OFF” and “ON” position.

If the N² switch module 200 (FIG. 2A) uses blocking-type mirrors, the switch module is characterized by the ON/OFF function of the mirrors 202 (FIG. 2A) that direct light between the input, output, and interconnect port(s). In this embodiment, the interconnect ports 208 may be diametrically opposite the input ports 204. Mirrors in the OFF position do not interact with the light, allowing it to pass to the next mirror, while mirrors in the ON position interact with the light beam, redirecting it from one particular input port 204 (FIG. 2A) to one particular output port 206. If all mirrors in a column are positioned in the OFF position, the optical signal will travel directly from an input port 204 to an interconnect port 208. However, a preferred embodiment of the invention allows an optical signal received at any input port to be routed to any output port or interconnect port.

FIG. 2D is a diagrammatic plan view of a multiple position movable mirror 250 for use in either of the optical switch modules 200 or 220 of FIGS. 2A and 2B, respectively. When required to reflect an incoming beam of light, the mirror is rotated about an axis 252 into position 256.

In a preferred embodiment of the 2N switch module 220 (FIG. 2B), each mirror 226 (FIG. 2B) stands perpendicular to its actuation plane 230 (FIG. 2B), and can be rotated through at least 5 to 15 degrees.

Both the N² and 2N architectures may be implemented in a planar two dimensional system, where each mirror has one degree of freedom or axis of rotation. Alternatively, a more complex three dimensional system may be provided, where each mirror has more than one degree of freedom or axis of rotation. The benefit to a planar system is that each mirror is less complex, and thus less expensive to design and manufacture. The benefit to a three dimensional system is that the mirrors and fiber optic cables can be packed more densely.

In an alternate embodiment, a combination of both types of optical switch modules described above in relation to FIGS. 1C and 1D can be used, i.e, these optical components are capable of rotating along either of the axes 246 (FIG. 2C) and 252 (FIG. 2D).

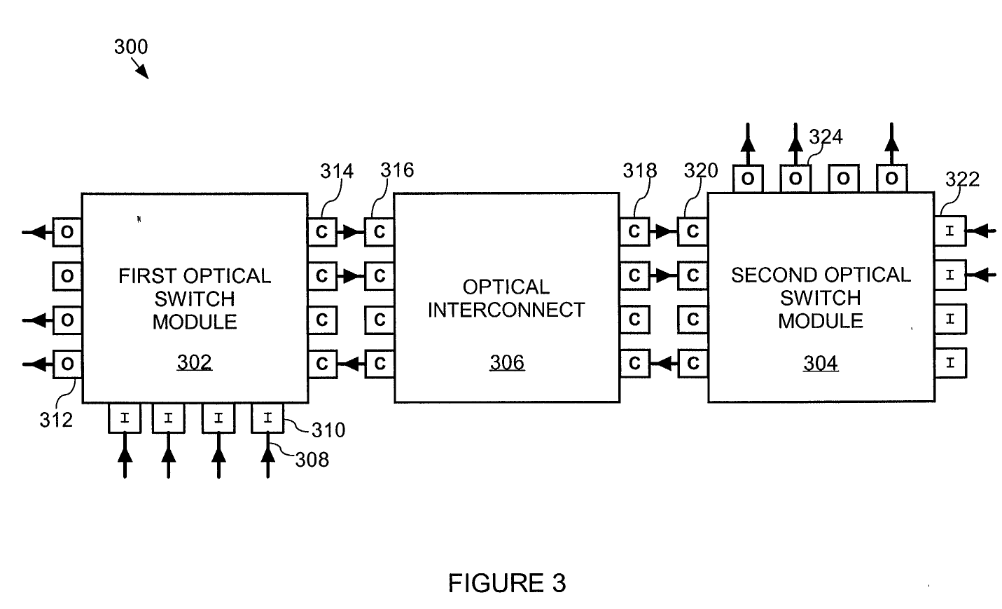

FIG. 3 is a diagrammatic representation of an optical modular switching system 300 according to an embodiment of the invention. The optical modular switching system 300 is configured as an optical cross-connect (OXC) or an optical add-drop multiplexer (OADM). An OXC is an all-optical switch module, while an OADM is an all-optical device that enables new optical signals to be added to a data stream and existing signals to be dropped out of an existing data stream.

The optical modular switching system 300 includes a first optical switch module 302, a second optical switch module 304, and an optical interconnect 306. The first optical switch module 302, and second optical switch module 304 are preferably the optical switch modules 200 (FIGS. 2A) or 220 (FIGS. 2B). Light 308 entering the first optical switch module 302 at input ports 310 is redirected or switched to either an output port 312 or an interconnect port 314. In this exemplary representation, two optical signals received at the input ports 310 are redirected to the interconnect port(s) 314, while two optical signals are redirected to output ports 312.

The optical signals sent to interconnect port(s) 314 are transmitted to first interconnect port(s) 316 of the optical interconnect 306. The optical interconnect 306 subsequently routes the optical signals to its second interconnect port(s) 318 which are coupled to the interconnect port(s) 320 of the second optical switch module 304. It should be noted that the optical interconnect 306 may operate in any one of the following ways: connecting interconnect port to interconnect port, such as via a optical fiber; connecting optical switch module to optical switch module, such as via a waveguide; or may have no confinement, thereby connecting optical switch modules to each other through free space. However, in a preferred embodiment, the interconnect ports 314 and interconnect ports 320 are not optically aligned via a free space.

The optical signals received at the interconnect port(s) 320 of the second optical switch module are then redirected by the second optical switch module to output ports 324. Additionally, any optical signals received by the input ports 322 of the second optical switch module 304 are also redirected to either the output ports 324 or the interconnect port(s) 320 of the second optical switch. In a similar manner to that described above, the optical signals received at the input ports 322 of the second optical switch module 304 can be switched through the optical interconnect 306 to the output ports 312 of the first optical switch module 302.

It should be noted that although the interconnect ports are shown as discrete ports, each set of interconnect ports may be one continuous interface, such as an elongate opening or window, i.e., each interconnect port may be no more complex than an opening through which light can pass. Furthermore, each interconnect port 314 and 320 may include a docking or latch mechanism that securely couples the interconnect port(s) 314 and 320 to the optical interconnect 306.

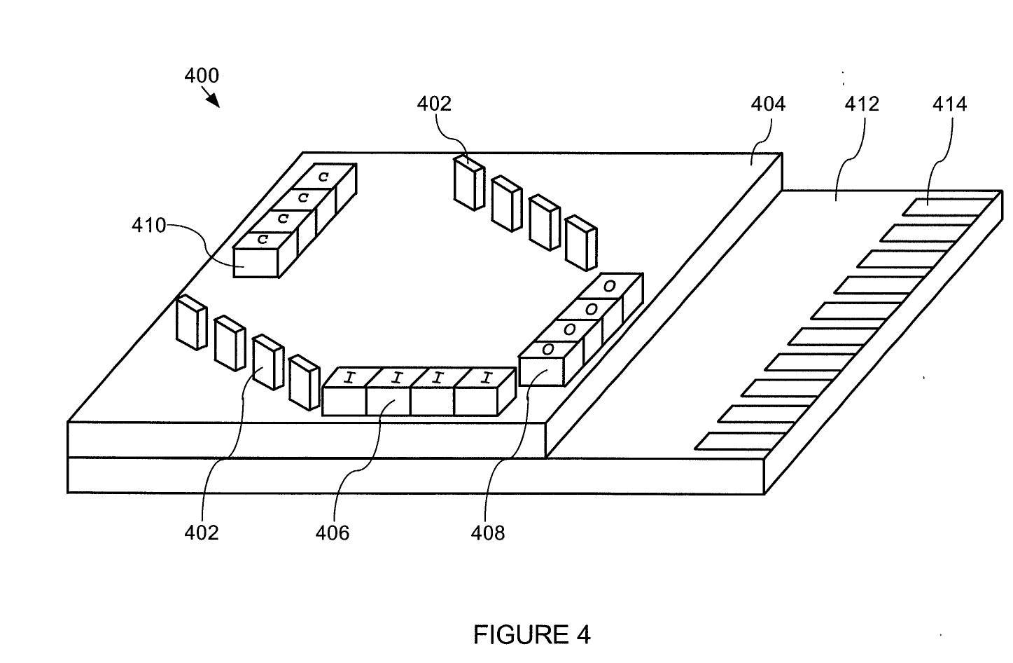

FIG. 4 is a oblique view of optical switch module 400 according to an embodiment of the invention. Optical switch module 400 is similar to the optical switch module 220 shown in FIG. 2B. Both the input ports 406 and the output ports 408 are configured to optically couple to optical fibers or cables (not shown). The interconnect port(s) 410 are configured to optical couple to the optical interconnect 306 (FIG. 3). The mirrors 402 are configured to rotate as described in relation to FIGS. 2B and 2D. The abovementioned components are disposed on an actuation plane or substrate 404. In a preferred embodiment, the substrate 404 is disposed on a printed circuit board 412 that includes electrical connectors 414 and may also include integrated circuitry (IC). The electrical connectors 414 preferably define an edge connector. The electrical connectors 414 are electrically coupled to actuators (not shown) that adjust the position of the mirrors 402. In a preferred embodiment, the actuators are electrostatic comb-drives. Alternatively, the actuators may be any type of electrostatic or magnetostatic actuators, piezoresistive actuators, thermal bimorphs, or the like. A more detailed explanation of such actuators may be found in either: Judy, J. W., Muller, R. S., Zappe, Magnetic microactuation of polysilicon flexure structures, H. H, Journal of Microelectromechanical Systems, Volume: 4 Issue: 4, Dec. 1995 Page(s): 162-169; Lin, L. Y., Lee, S. S., Pister, K. S. J., Wu, Micro-machined three-dimensional micro-optics for integrated free-space optical system, M.C. IEEE Photonics Technology Letters, Volume: 6 Issue: 12, Dec. 1994 Page(s): 1445-1447; Ataka, M.; Omodaka, A.; Takeshima, N.; Fujita, H, Fabrication and operation of polyimide bimorph actuatorsfor a ciliary motion system, Journal of Microelectromechanical Systems, Volume: 2 Issue: 4, Dec. 1993. P 146-150; or M. Hoffinann, P. Kopka, E. Voges, Bistable micromechanicalfiber-optic switches on silicon with thermal actuators, Sensors and Actuators, Volume 78, 1999. Pages 28-35, all of which are incorporated herein by reference.

The optical switch module 400 is preferably a micromachined optical switch fabricated using MEMS technology. Furthermore, the optical switch module 400 is preferably based on the 2N or N² optical switch modules described above in relation to FIGS. 2A & 2B. Also, micromachined mirrors used in the optical switch modules have at least one degree of freedom (DOF).

It should be appreciated that the input ports described above are for receiving input signals into each optical switch module, while the output ports are for transmitting output signals from each optical switch module and not for transmitting optical signals between modules.

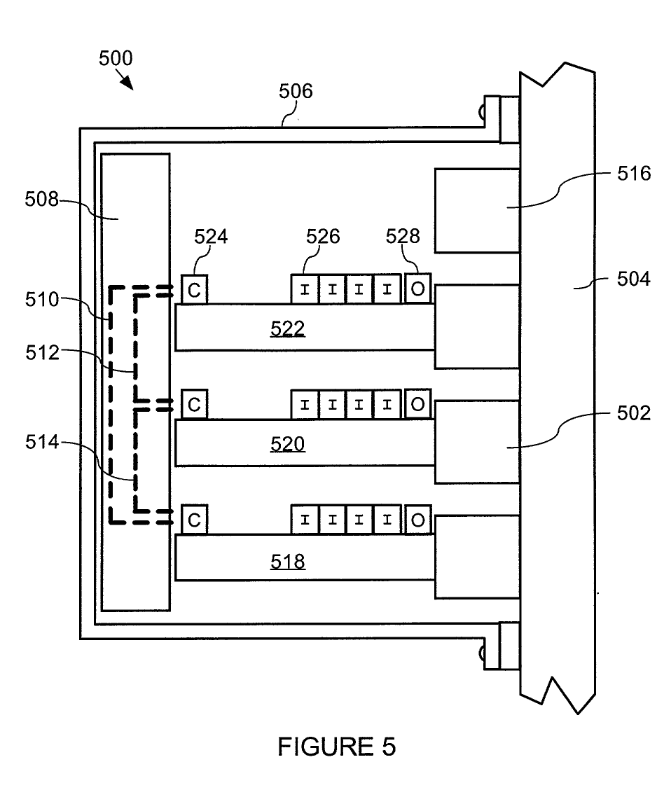

FIG. 5 is a diagrammatic partial cross-sectional view of an optical modular switching system 500 according to an embodiment of the invention. It should be noted that FIG. 5 is a conceptual representation and is not intended to limit the structure of the optical modular switching system 500 in any way. The optical modular switching system 500 includes multiple optical switch modules 518, 520, and 522. The optical switch modules 518, 520, and 522 include micro-mirror arrays that direct light through free-space between optical ports. In a preferred embodiment, the optical switch modules 518, 520, and 522 are those described in relation to FIGS. 2A, 2B and 4 above. Furthermore, each individual optical switch module can function independently of the others.

Each optical switch module 518, 520, and 522 includes one or more input ports 526, output ports 528 and interconnect port(s) 524. In a preferred embodiment, the optical switch modules 518, 520, and 522 connect to a printed circuit board 504 via connectors 502. Should the optical switch module 400 shown and described in relation to FIG. 4 be used as the optical switch module 518, 520, or 522 of this embodiment, then the connectors 502 are female connectors for receiving the electrical connectors 414 of FIG. 4. Electrical signals sent along the printed circuit board 504 are used to control actuators coupled to the mirrors (not shown) in each switch module. Although not shown, optical fibers or cables are coupled to the input 526 and output 528 ports.

The optical modular switching system 500 also includes an optical interconnect 508 similar to the optical interconnect 306 shown and described in relation to FIG. 3. The optical interconnect 508 optically couples the optical switch modules 518, 520, and 522 to one another. For example, optical signals can be routed as follows: along a first path 510 between optical switch module 522 and optical switch module 518; along a second path 512 between optical switch module 522 and optical switch module 520; and along a third path 514 between optical switch module 520 and optical switch module 518. In a preferred embodiment, the optical switch modules 518, 520, and 522 are assembled one on top of the other, i.e., substantially parallel to one another.

Additional optical switch modules can be added to the optical modular switching system 500 by plugging additional optical switch modules into the system. In a preferred embodiment, this can be accomplished by slotting additional optical switch modules into extra connectors, one of which is shown as additional connector 516, disposed in the optical modular switching system 500. This allows for upgrading and scalablity of the optical modular switching system 500. In a preferred embodiment, adding additional optical switch modules requires adding additional optical interconnects between the new switch module and each existing switch.

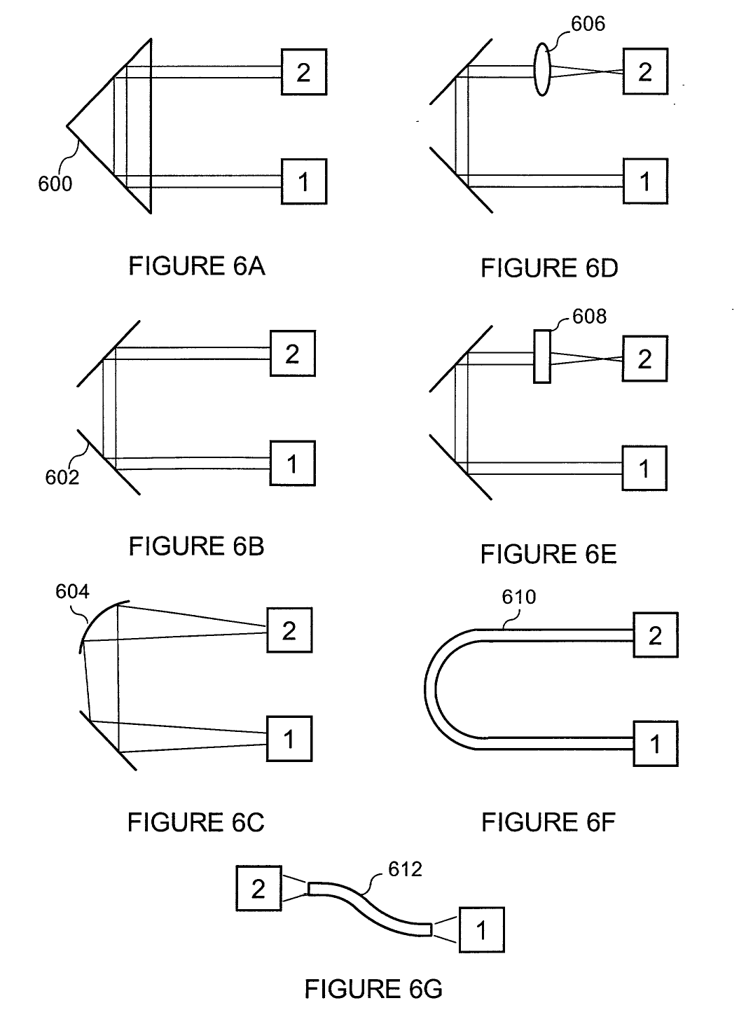

FIGS. 6A to 6G are diagrammatic side views of various embodiments of the optical interconnect 508 of FIG. 5. The optical interconnect 508 (FIG. 5) includes one or more optical components that redirect an optical signal from a first interconnect port, shown as numeral 1, on one optical switch module to a second interconnect port, shown as numeral 2, on another optical switch module. These optical components are preferably simple plane mirrors 602 (FIG. 6B), but may be prisms 600 (FIG. 6A), curved mirrors 604 (FIG. 6C), refractive lenses 606 (FIG. 6D), Fresnel lenses 608 (FIG. 6E), diffractive lenses 608 (FIG. 6E), optical fibers 610 (FIG. 6F), waveguides 612 (FIG. 6G), or the like. The optical elements can be fixed or moveable, rigid or flexible, and can range in size from 10 micrometers to several centimeters (cm).

The scanning optical elements, such as mirrors 602 or 604, can be driven by integrated, on-chip actuators (integrated actuation), by external actuators, or by a combination of on-chip and external actuators. Integrated actuation mechanisms include but are not limited to electrostatic actuators, magnetostatic actuators, piezoresistive actuators, thermal bimorphs, or any suitable mechanism described above.

The curved mirror 604 (FIG. 6C) and refractive lenses 606 (FIG. 6D) may further be used to focus the light beam and correct beam dispersion. The Fresnel lenses 608 (FIG. 6E) may further be used to collimate the beam, while the diffractive lenses 608 (FIG. 6E) may be used to minimize abbreviation by keeping the focus distance of all wavelengths close to each other.

As described above, the optical interconnect can either include movable optical components, such as movable mirrors, or static optical components, such as static waveguides. If movable components are used, the optical interconnect is said to be active, while if static components are used the optical interconnect is said to be passive. Furthermore, in a preferred embodiment the optical interconnect is a physical structure containing optical components, and not merely optical fibers or free space.

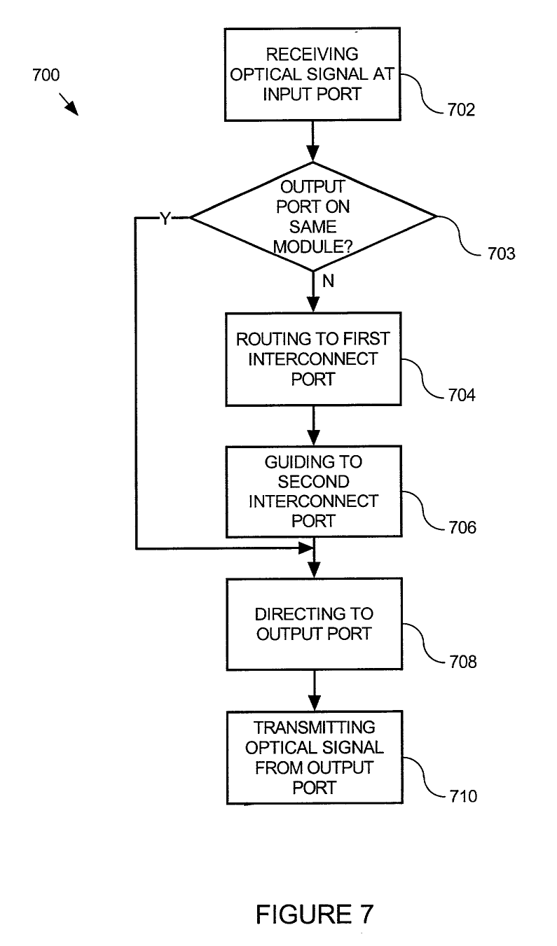

FIG. 7 is a flow chart 700 of a method for switching an optical signal according to an embodiment of the invention. An optical signal is firstly received (step 702) at an input port 526 (FIG. 5) of a first optical switch module 518, 520, or 522 (FIG. 5). If the optical signal is to be routed to an output port on another optical switch module (703—No), then the optical signal is routed (step 704) to a first optical interconnect port 524 (FIG. 5) of the first optical switch module 518, 520, or 522 (FIG. 5). The optical signal is subsequently guided (step 706) to a second interconnect port 524 (FIG. 5) of a second optical switch module 518, 520, or 522 (FIG. 5). The optical signal is then directed (step 708) to an output port 528 (FIG. 5) of the second optical switch module 518, 520, or 522 (FIG. 5). Finally, the optical signal is transmitted (step 710) from the output port.

It should be appreciated that although the above description primary describes the optical switch modules as containing mirrors, any suitable optical components may be substituted. Such suitable optical components may for example be waveguides, prisms, simple plane mirrors, curve mirrors, refractive lenses, reflective lenses, Fresnel lenses, diffractive lenses, and the like.

The foregoing descriptions of specific embodiments of the present invention are presented for purposes of illustration and description. They are not intended to be exhaustive or to limit the invention to the precise forms disclosed, obviously many modifications and variations are possible in view of the above teachings. For example, modules other than N² or 2N can be used. Also, non MEMS optical components may be used, if appropriate. The embodiments were chosen and described in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents.

What is claimed is:

1. An optical modular switching system, comprising:
a first optical switch module having at least one first optical input port, at least one first optical output port, and at least one first interconnect port;
a second optical switch module having at least one second optical input port, at least one second optical output port, and at least one second interconnect port; and
an optical interconnect that optically couples said first optical interconnect port to said second optical interconnect port.

2. The optical modular switching system of claim 1, wherein said first optical switch module and said second optical switch module are micro-optical-electromechanical switches.

3. The optical modular switching system of claim 1, wherein said first optical switch module, said second optical switch module, and said optical interconnect are all contained within a housing.

4. The optical modular switching system of claim 1, wherein said first optical switch module is a 2N type optical switch module.

5. The optical modular switching system of claim 1, wherein said first optical switch module is a N² type optical switch module.

6. The optical modular switching system of claim 1, wherein said second optical switch module is a 2N type optical switch module.

7. The optical modular switching system of claim 1, wherein said second optical switch module is a N² type optical switch module.

8. The optical modular switching system of claim 1, wherein said optical interconnect is passive.

9. The optical modular switching system of claim 1, wherein said optical interconnect is active.

10. The optical modular switching system of claim 1, wherein said optical interconnect is an optical add-drop multiplexer.

11. The optical modular switching system of claim 1, wherein said optical interconnect includes components selected from a group comprising of: a simple plane mirror, a prism, a curved mirror, a refractive lens, a Fresnel lens, a diffractive lens, an optical fiber, and a waveguide.

12. An optical modular switching system, comprising:
a housing;
at least two optical switch modules disposed within said housing, where each of said optical switch modules includes at least one optical input port, one optical output port, and one interconnect port; and
an optical interconnect within said housing, where said optical interconnect optically couples said at least two optical switch modules to one another, via said interconnect ports.

13. A method for switching an optical signal in an optical modular switching system, comprising:
receiving an optical signal at an input port of a first optical switch module;
routing said optical signal to a first optical interconnect port of said first optical switch module;
guiding said optical signal to a second interconnect port of a second optical switch module;
directing said optical signal to an output port of said second optical switch module; and
transmitting said optical signal from said output port.

14. The method of claim 13, wherein said routing comprises reflecting said optical signal from said input port to said first optical interconnect port.

15. The method of claim 13, wherein said guiding comprises reflecting said optical signal from said first optical interconnect port to said second interconnect port.

16. The method of claim 13, wherein said directing comprises reflecting said optical signal from said second interconnect port to said output port.
